(19) United States
(12) Patent Application Publication
(10) Pub. No.: US 2006/0286437 A1
(43) Pub. Date: Dec. 21, 2006

(54) Polymer electrolyte fuel cell and manufacturing method

(75) Inventors: Shigeru Aihara, Tokyo (JP); Hisatoshi Fukumoto, Tokyo (JP); Takashi Nishimura, Tokyo (JP); Masayuki Hamayasu, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Electric Corporation, Tokyo (JP)

(21) Appl. No.: 11/452,913

(22) Filed: Jun. 15, 2006

(30) Foreign Application Priority Data
Jun. 21, 2005 (JP) 2005-180787

(51) Int. Cl. H01M 4/94; H01M 4/96; H01M 8/10; H01M 4/88; B05D 5/12

(52) U.S. Cl. 429/44; 429/42; 429/30; 502/101; 427/115

(57) ABSTRACT

An intermediate layer is disposed between respective gas diffusing layers and catalyst layers of a polymer electrolyte fuel cell. This intermediate layer is mainly an electron-conductive filler and a binder, and has voids that are continuous in a thickness direction inside the intermediate layer, the intermediate layer has a solid volume percentage that is at least 3 percent and no larger than 30 percent, and a volume ratio occupied by voids that have a void diameter that is at least 1 μm and no larger than 30 μm of at least 50 percent of overall intermediate layer volume.

### BACKGROUND OF THE INVENTION

1. Field of the Invention

The present invention relates to a polymer electrolyte fuel cell and manufacturing method, and more specifically relates to a polymer electrolyte fuel cell that includes an intermediate layer that enables electric cell efficiency to be increased and also enables bondability between catalyst layers and gaseous diffusing layers to be improved by enabling gas to be supplied to the catalyst layers efficiently and continuously, and to a method for manufacturing such a cell.

2. Description of the Related Art

Clean power generating systems have been in demand in recent years due to increasing awareness of environmental problems, and fuel cells have been attracting attention as one such system. These fuel cells can be classified according to the type of electrolyte used into phosphoric acid fuel cells, molten carbonate fuel cells, solid electrolyte fuel cells, polymer electrolyte fuel cells, etc., and among these, research and development relating to polymer electrolyte fuel cells is being actively promoted, since they are superior in having low power generation temperatures and being compact.

Polymer electrolyte fuel cells of this kind have: a proton-conductive polymer electrolyte membrane; an anode catalyst layer and a cathode catalyst layer that are disposed on two sides of the polymer electrolyte membrane; and first and second gas diffusing layers that are disposed outside the respective catalyst layers and that diffuse gas from first and second gas supply channels to the catalyst layers. Intermediate layers are often disposed between the catalyst layers and the gas diffusing layers. In addition, first and second separator plates into which gas channels that supply gas are carved are disposed outside the gas diffusing layers.

These polymer electrolyte fuel cells can be operated as fuel cells by respectively supplying a fuel gas (such as hydrogen gas, or a reformed gas, for example) to the anode catalyst layer and an oxidizer (such as air, or oxygen gas, for example) to the cathode catalyst layer, and connecting the two electrodes to an external circuit. Specifically, hydrogen gas, for example, is first supplied from the first gas channel that is formed on the first separator plate through the first gas diffusing layer to the anode catalyst layer. Hydrogen gas that has reached the anode catalyst layer then generates a proton and an electron through an oxidation reaction with the catalyst. This proton passes through the solid polymer electrolyte membrane and moves to the cathode catalyst layer. The electron, on the other hand, passes through the external circuit and reaches the cathode catalyst layer. At the cathode catalyst layer, the proton that has passed through the solid polymer electrolyte membrane, an electron sent from the external circuit, and oxygen gas, for example, that is supplied through the second gas diffusing layer from the second gas channel that is formed on the second separator plate react at the surface of the catalyst and are converted to water. At that point, electromotive force is generated between the electrodes and can be extracted as electric energy.

To perform the reactions described above efficiently and continuously, it is important to reduce ion conduction resistance and electron conduction resistance and to supply the gases to the anode and cathode catalyst layers continuously. To reduce the ion conduction resistance, it is necessary to keep the polymer electrolyte components in a constantly moist state using water. In order to lower the electron conduction resistance, it is necessary to lower the resistance of each of the members, including the catalyst layers, the gas diffusing layers, and the separator plates, and it is also necessary to make the contact resistance between each of the members as low as possible. However, since the gas diffusing layers are porous layers made of carbon fibers, etc., it is difficult to lower the contact resistance between the members. Because of this, adaptations have been made such as disposing porous intermediate layers that are made of electron-conductive materials on the surface of the gas diffusing layers to improve contact with the catalyst layers and lower electron resistance.

On the other hand, it is necessary to continuously discharge water that has been generated by the cathode catalyst layer because if the generated water accumulates at the surface of the catalyst layer, or void portions in the gas diffusing layer are blocked by the water, etc., then contact between the gas and the catalyst layer is obstructed. In order to avoid the void portions in the gas diffusing layers being blocked by water, the electrode materials are widely made water repellent using water-repellent materials such as fluorine resins, etc. The gas diffusing layers in particular are supply pathways that make the gas that has been supplied from the gas channels reach the catalyst layers, and are generally made water repellent.

In polymer electrolyte fuel cells of this kind, as described above, ion conduction resistance is reduced and performance is improved as the moisture content in the polymer electrolyte membrane is increased. For this reason, the reactant gases are humidified using external humidifiers before being supplied so as to maintain the polymer electrolyte membrane in a moist state. If polymer electrolyte fuel cells are operated in low-humidity conditions, the moisture content of the polymer electrolyte membrane is reduced and performance is reduced significantly. Because of this, it is more desirable to operate polymer electrolyte fuel cells under high-humidity conditions as close as possible to saturated vapor pressure at any given temperature. However, being close to the saturated vapor pressure, water vapor is more likely to become liquid water inside the pores of the gas diffusing layers, the intermediate layers, and the catalyst layers, etc., due to the influence of the cell temperature, the generated water, etc., and there is a possibility that the pores may become blocked. For this reason, adaptations are required such that as little liquid moisture as possible accumulates in the pores of the intermediate layers, etc. Commonly-known examples of such methods include the following techniques.

In a first conventional method for manufacturing fuel cells, when forming intermediate layers, two types (large and small) of carbon particles that have different centers of distribution of particle diameter are mixed together so as to configure a construction that has at least two centers of distribution with regard to distribution of gas cavity diameter (see Patent Literature 1, for example).

In a second conventional method for manufacturing fuel cells, when forming intermediate layers, voids are formed by producing a wet water-base paste, further adding and dispersing a second solvent that is insoluble in water and has a high boiling point, applying then drying the paste such that only water is evaporated, and then drying the paste in such a way that the second solvent is evaporated (see Patent Literature 2, for example).

Patent Literature 1: Japanese Patent Laid-Open No. 2001-057215 (Gazette)

Patent Literature 2: Japanese Patent Laid-Open No. 2002-367617 (Gazette)

However, in the first conventional method for manufacturing fuel cells, two types (large and small) of carbon particles that have different particle diameters are mixed together, and one problem has been that it is difficult to form void diameters according to design simply by mixing alone since the small-diameter particles enter the void portions that the large-diameter particles form.

In the second conventional method for manufacturing fuel cells, it is difficult to disperse the second solvent into the paste stably, and another problem is that manufacturing processes such as controlling the drying temperature, etc., are complicated.

### SUMMARY OF THE INVENTION

The present invention aims to solve the above problems and an object of the present invention is to provide a polymer electrolyte fuel cell that enables initial electric cell characteristics to be maintained for a long time by adopting a construction that improves flow of reactant gases from gas diffusing layers to catalyst layers and that suppresses accumulation of moisture that is generated by electrode reactions and water of condensation of water vapor in humidified gases, etc., in the catalyst layers and intermediate layers, etc., and to provide a method by which such a polymer electrolyte fuel cell can be manufactured simply.

In order to achieve the above object, according to one aspect of the present invention, there is provided a polymer electrolyte fuel cell including: a proton-conductive polymer electrolyte membrane; anode and cathode catalyst layers that are disposed on two sides of the polymer electrolyte membrane; gas diffusing layers that are disposed on opposite sides of the anode and cathode catalyst layers from the polymer electrolyte membrane and that diffuse reactant gases to the anode and cathode catalyst layers; and an intermediate layer that is disposed between at least one catalyst layer of the anode and cathode catalyst layers and at least one of the gas diffusing layers and that contains an electron-conductive filler and a binder. The intermediate layer has voids that are distributed continuously in a thickness direction, and has a solid volume percentage that is greater than or equal to 3 percent and less than or equal to 30 percent. A volume ratio occupied by voids that have a void diameter that is greater than or equal to 1 μm and less than or equal to 30 μm is greater than or equal to 50 percent of an overall intermediate layer volume.

According to another aspect of the present invention, there is provided a polymer electrolyte fuel cell manufacturing method for manufacturing a polymer electrolyte fuel cell including: a proton-conductive polymer electrolyte membrane; anode and cathode catalyst layers that are disposed on two sides of the polymer electrolyte membrane; gas diffusing layers that are disposed on opposite sides of the anode and cathode catalyst layers from the polymer electrolyte membrane and that diffuse reactant gases to the anode and cathode catalyst layers; and an intermediate layer that is disposed between at least one catalyst layer of the anode and cathode catalyst layers and at least one of the gas diffusing layers and that contains an electron-conductive filler and a binder. The polymer electrolyte fuel cell manufacturing method includes steps of: applying a paste that contains the electron-conductive filler, the binder, a thermally-dissipating filler, an additive, and a solvent to a surface of the gas diffusing layer; drying the paste that has been applied to the gas diffusing layer by evaporating the solvent; and forming the intermediate layer integrally on the surface of the gas diffusing layer by heat-treating the gas diffusing layer to which the dried paste has been applied to a temperature that is greater than or equal to 200 degrees Celsius and less than or equal to 450 degrees Celsius to make the thermally-dissipating filler dissipate.

According to the present invention, because voids are distributed continuously in a thickness direction inside the intermediate layer, and the volume ratio occupied by voids that have a void diameter that is greater than or equal to 1 μm and less than or equal to 30 μm is greater than or equal to 50 percent of the overall intermediate layer volume, moisture that is generated by electrode reactions and water of condensation of water vapor in humidified gases are less likely to accumulate in the intermediate layer. Thus, reactant gases can diffuse efficiently from the gas diffusing layers to the catalyst layers, enabling initial electric cell characteristics to be maintained for a long time.

According to the present invention, because the gas diffusing layer to which the dried paste has been applied is heat treated to a temperature that is greater than or equal to 200 degrees Celsius and less than or equal to 450 degrees Celsius, the thermally-dissipating filler contained in the paste dissipates due to the heat treatment. Voids that have diameters equal to those of the thermally-dissipating filler particles are thereby formed in the intermediate layer by the dissipation of the thermally-dissipating filler in addition to the voids formed by the electron-conductive filler. Thus, a polymer electrolyte fuel cell that has an intermediate layer that has a construction that improves flow of reactant gases from the gas diffusing layers to the catalyst layers and that suppresses accumulation of moisture that is generated by electrode reactions and water of condensation of water vapor in humidified gases, etc., in the catalyst layers and the intermediate layers, etc., can be manufactured simply.

### BRIEF DESCRIPTION OF THE DRAWINGS

FIG. 1 is a cross section explaining a construction of a polymer electrolyte fuel cell according to the present invention;

FIG. 2 is a partial cross section showing a vicinity of an intermediate layer in the polymer electrolyte fuel cell according to the present invention;

FIG. 3 is a cross-sectional image of an intermediate layer precursor before heat treatment in a polymer electrolyte fuel cell manufacturing method according to the present invention; and

FIG. 4 is a cross-sectional image of the intermediate layer after heat treatment in the polymer electrolyte fuel cell manufacturing method according to the present invention.

### DETAILED DESCRIPTION OF THE PREFERRED EMBODIMENT

A preferred embodiment of the present invention will now be explained with reference to the drawings.

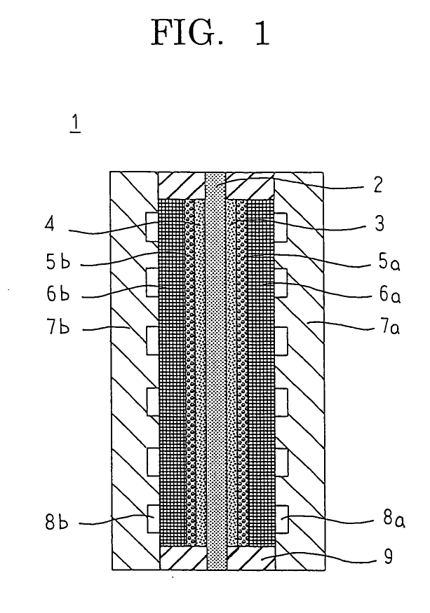

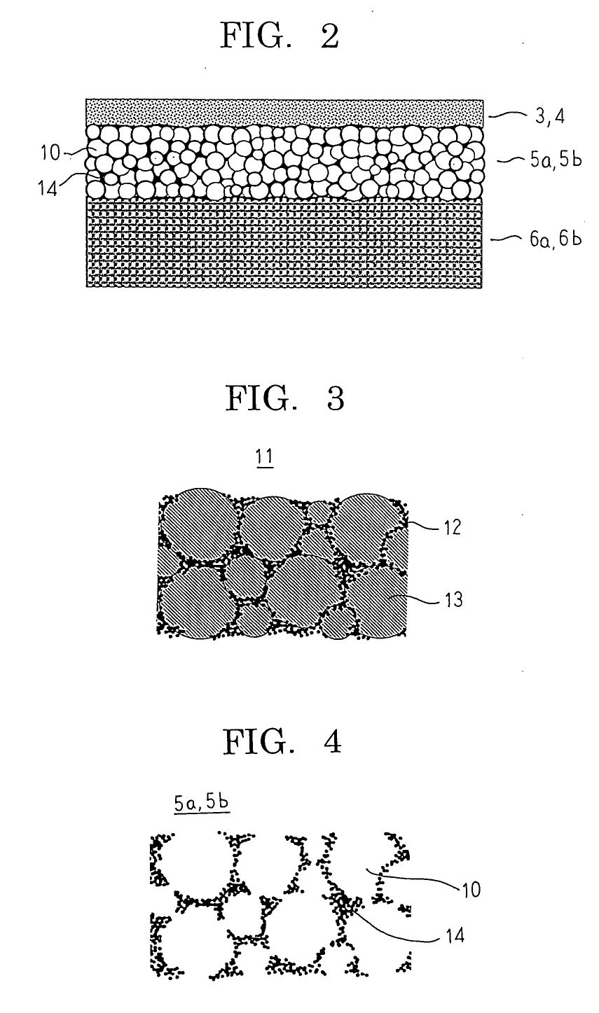

FIG. 1 is a cross section explaining a construction of a polymer electrolyte fuel cell according to the present invention, and FIG. 2 is a partial cross section showing a vicinity of an intermediate layer in the polymer electrolyte fuel cell according to the present invention.

In FIG. 1, a polymer electrolyte fuel cell 1 includes: a proton-conductive polymer electrolyte membrane 2; an anode catalyst layer 3 and a cathode catalyst layer 4 that are disposed on two sides of the polymer electrolyte membrane 2; first and second intermediate layers 5a and 5b that are disposed on opposite sides of the anode catalyst layer 3 and the cathode catalyst layer 4, respectively, from the polymer electrolyte membrane; first and second gas diffusing layers 6a and 6b that are disposed outside the first and second intermediate layers 5a and 5b; first and second separator plates 7a and 7b that are disposed outside the first and second gas diffusing layers 6a and 6b and in which first and second gas channels 8a and 8b that supply gases are formed; and gas seal portions 9.

In this polymer electrolyte fuel cell 1, the intermediate layers 5a and 5b have a solid volume percentage that is greater than or equal to 3 percent and less than or equal to 30 percent and have voids that are continuous in a thickness direction inside the intermediate layers, and in addition the voids are formed such that a volume ratio occupied by voids that have a void diameter that is greater than or equal to 1 μm and less than or equal to 30 μm is greater than or equal to 50 percent of an overall intermediate layer volume. In addition, the intermediate layers 5a and 5b are formed so as to have a gas permeability (International Organization for Standardization (ISO) standard) that is greater than or equal to 100 μm/(Pa·s).

Here, for the material for the polymer electrolyte membrane 2, it is possible to use any material without particular limitation provided that the material is chemically stable even in the environment inside the fuel cell, and has high proton conductivity and gas impermeability, and also has no electron conductivity. Generally, polymer electrolyte membranes in which sulfonic acid groups are appended to perfluoric backbones are often used but the material is not limited to these, and it is possible to use hydrocarbons, etc.

Examples of components contained in the anode catalyst layer 3 include, for example, catalysts that have a catalytic ability to make hydrogen, or other gases or liquids used as fuel for the fuel cell, react. Anode catalysts that can be used include, but are not particularly limited to: platinum; alloys of platinum and noble metals (such as ruthenium, rhodium, iridium, etc.); and alloys of platinum and base metals (such as vanadium, chrome, cobalt, nickel, iron, etc.), etc., carried on surfaces of carbon black microparticles, etc., for example. Examples of other components include polymer electrolyte components. Water repellents such as polytetrafluoroethylene (PTFE) particles, etc., a binder that binds the particles together, and conducting agents such as carbon black, etc., that improve electrical conductivity, etc., may be also be included.

Examples of components contained in the cathode catalyst layer 4 include, for example, catalysts that have a catalytic ability to make oxygen react. Cathode catalysts that can be used include, but are not particularly limited to: platinum; alloys of platinum and noble metals (such as ruthenium, rhodium, iridium, etc.); alloys of platinum and base metals (such as vanadium, chrome, cobalt, nickel, iron, etc.), etc., carried on surfaces of carbon black microparticles; and platinum black, etc., for example. Examples of other components include polymer electrolyte components. Water repellents such as polytetrafluoroethylene (PTFE) particles, etc., a binder that binds the particles together, and conducting agents such as carbon black, etc., that improve electrical conductivity, etc., may be also be included.

These anode and cathode catalyst layers 3 and 4 may be formed on the polymer electrolyte membrane 2, may be formed on surfaces of the intermediate layers 5a and 5b that are formed on the gas diffusing layers 6a and 6b, or may be formed as sheets and disposed between the polymer electrolyte membrane 2 and the intermediate layers 5a and 5b.

The gas diffusing layers 6a and 6b are not particularly limited provided that they have electron conductivity, and have materials and constructions that enable the reactant gases to be diffused from the gas channels 8a and 8b to the anode and cathode catalyst layers 3 and 4, but most often they are porous layers that are mainly made of carbonous materials, and specifically, porous materials that are formed using carbon fibers such as carbon paper, carbon cloth, nonwoven carbon fabric, etc., can be used. Furthermore, surface treatments such as water-repellent treatments, hydrophilic treatments, etc., may also be applied to surfaces of these gas diffusing layer components.

The separator plates 7a and 7b, on surfaces of which the gas channels 8a and 8b are formed, are not particularly limited provided that they have electron conductivity, and enable the gas channels 8a and 8b and cooling water flow channels (not shown) to be formed, but they may be metals such as stainless alloys, etc., plates that are made of carbon, or materials that are made of mixtures of carbon and resins.

It is necessary for the intermediate layers 5a and 5b according to the present invention, which are disposed between the gas diffusing layers 6a and 6b and the catalyst layers 3 and 4, to have electron conductivity since functioning to reduce the contact resistance between the gas diffusing layers 6a and 6b and the catalyst layers 3 and 4 is most important. Consequently, the material of a filler that constitutes a portion of a skeleton 14 of the intermediate layers 5a and 5b is not particularly limited provided that it has electron conductivity, but carbon materials are preferable because they have good moldability and also electrical conductivity and they are superior in chemical stability, and carbon microparticles in particular such as carbon black, etc., are more preferable because they fulfill these conditions. Mean primary particle diameter of the filler that constitutes a portion of the skeleton 14 of the intermediate layers, i.e., the electron-conductive filler, is not particularly limited, but it is desirable for it to be approximately 20 nm to 500 nm when consideration is given to moldability and gas permeability.

It is necessary for the intermediate layers 5a and 5b to have porosity since it is necessary for them to supply the reactant gases and moisture from the gas diffusing layers 6a and 6b to the catalyst layers 3 and 4 or to discharge the moisture that has been generated in the cathode catalyst layer 4 to the second gas diffusing layers 6b. Here, if the volume ratio that is occupied by solid content relative to the overall intermediate layer volume is expressed as a solid volume percentage, then it is desirable for the solid volume percentage to be greater than or equal to 3 percent and less than or equal to 30 percent. If the solid volume percentage is less than 3 percent, it becomes difficult to maintain the shape of the intermediate layers since solid content is insufficient, and if the solid volume percentage is greater than 30 percent, pore volume becomes insufficient and gas permeability is reduced. However, it is difficult to maintain satisfactory gas permeability only using voids that arise between the electron-conductive filler that forms a portion of the skeleton 14 of the intermediate layers since the void diameters therein are too fine. For that reason, it is desirable to form voids that have a void diameter that is greater than or equal to 10 times the void diameter of the voids that the electron-conductive filler forms, i.e., macropores 10 (see FIG. 2). In addition, it is desirable for these macropores 10 to be voids that are continuous in a thickness direction inside the intermediate layers, and for the voids to have a volume ratio occupied by voids that have a void diameter that is greater than or equal to 1 μm and less than or equal to 30 μm that is greater than or equal to 50 percent of the overall intermediate layer volume. If maximum void diameter is less than 1 μm, gas permeability is reduced, and satisfactory characteristics cannot be maintained. If, on the other hand, voids that have a maximum void diameter that is greater than 30 μm are included, contact resistance with the catalyst layers increases since surface roughness of the intermediate layers is increased and flatness becomes poor, and this can become a cause of deterioration in characteristics.

As a result of diligent investigation into what degree of gas permeability the intermediate layers 5a and 5b must have if they are to be intermediate layers that enable satisfactory electric cell characteristics to be maintained for a long time, it has been found that the quality of the gas permeation can be determined by measuring the gas permeability inside the intermediate layers 5a and 5b, and it has been confirmed in the gas permeability according to ISO standards that electric cell characteristics can be maintained for a long time provided that the gas permeability is greater than or equal to 100 μm/(Pa·s). Moreover, the gas permeability was measured using a commercially-available gas permeability meter. Here, gas permeability according to ISO standards is expressed as the quantity of flow of air passing through a porous sheet/plate of unit area per unit time under a constant pressure difference.

The intermediate layers 5a and 5b may also contain a binder for molding the electron-conductive filler, water repellents for imparting water repellency, and hydrophilic agents for imparting hydrophilicity, etc. If a fluorine resin is used as both a binder and a water repellent, it is preferable for it to have stability even in the electric cell system, and polytetrafluoroethylene (PTFE), tetrafluoroethylene-hexafluoropropylene copolymer (FEP), etc., are more preferable since they are superior in water repellency and heat resistance. In order to impart hydrophilicity, polymer electrolyte components such as perfluorosulfonic acids, etc., may also be included.

The intermediate layers 5a and 5b may also be formed into sheets constituted only by intermediate layers and disposed between the catalyst layers 3 and 4 and the gas diffusing layers 6a and 6b. The intermediate layer sheets thus formed may also be integrated with the gas diffusing layers 6a and 6b by crimping them using a press, etc. However, the most simple and convenient method is to form the intermediate layers 5a and 5b directly on the gas diffusing layers 6a and 6b by applying and heat treating an intermediate layer paste directly on the gas diffusing layers 6a and 6b, and this is also preferable because contact with the gas diffusing layers is also improved.

Examples of methods for forming these intermediate layers 5a and 5b include dry forming methods in which the filler, binder, etc., are mixed together in a dry form and molded, and wet pressing in which they are formed by dispersing the filler, binder, etc., in a solvent and evaporating the solvent by drying after application. Wet pressing is preferable when consideration is given to ease of molding, and simplicity and convenience of thickness control, etc. When using wet methods, it is also possible to premix dispersing agents such as polyoxyethylene derivatives, etc., thickeners such as cellulose derivatives (such as sodium carboxymethylcellulose, hydroxyethylcellulose, etc., for example), etc., into the solvent in addition to the filler and binder, and by adding these it is possible to prepare a paste solution that is stable and productive. Intermediate layer thickness here should be greater than or equal to 5 μm and less than or equal to 100 μm. If the intermediate layer thickness is greater than 100 μm, gas permeation resistance increases, reducing gas supply, drainage, etc. If the intermediate layer thickness is less than 5 μm, power collection effects are reduced, reducing voltage characteristics.

In the intermediate layers 5a and 5b, as a means of additionally producing voids (macropores) that have a larger void diameter than the voids that are formed by the electron-conductive filler that constitutes a portion of the skeleton 14, one method is to add a thermally-dissipating filler to the intermediate layer preparatory paste. A “thermally-dissipating filler” means a filler that is made of a material that decomposes combustively (by oxidation reaction) or thermally at greater than or equal to a predetermined temperature. Specific examples that qualify as thermally-dissipating fillers include polymeric materials, subliming materials, etc. Consequently, by adding a thermally-dissipating filler that has a predetermined particle diameter to an intermediate layer preparatory paste, and performing heat treatment on the applied film of paste at the temperature at which the thermally-dissipating filler decomposes combustively or thermally, voids that have particle diameters and volumes that are equivalent to those of the thermally-dissipating filler can be formed. Here, if the volume fraction of the thermally-dissipating filler in the paste is greater than or equal to 50 percent, continuous pores can be achieved since the respective particles of the thermally-dissipating filler contact each other in the applied film of paste. Thus, intermediate layers 5a and 5b can be obtained that have voids that are continuous in the thickness direction inside the intermediate layers. It is preferable if the mean particle diameter of the thermally-dissipating filler are greater than or equal to 1 μm and less than or equal to 30 μm because voids that have that diameter will be formed.

It is preferable if the thermally-dissipating filler is a material of which greater than or equal to 90 percent decomposes combustively (by oxidation reaction) or thermally at a temperature between 200 degrees Celsius and 450 degrees Celsius because then heat treatment is ultimately possible without affecting the electron-conductive filler and binder that form the intermediate layer. The material of the thermally-dissipating filler is not particularly limited provided that it is a material of which greater than or equal to 90 percent decomposes combustively (by oxidation reaction) or thermally at a temperature between 200 degrees Celsius and 450 degrees Celsius, but polymeric materials are easy to obtain, and are harmless and easy to handle because their decomposition products are also carbon dioxide gas, moisture, etc. In particular, polymers of methacrylate esters(methyl methacrylate, butyl methacrylate, etc., for example), derivatives of such polymers, or mixtures thereof can be used as the material for the thermally-dissipating filler because they dissipate in the temperature range described above. The shape of the thermally-dissipating filler is not particularly limited, but can be a globular, spherical, nonspherical, baculiform, fibriform, or squamiform shape, etc. Moreover, mean particle diameter can be taken to be a mean value of a long axis and a short axis.

In the wet pressing described above, a paste in which an electron-conductive filler, a binder, a thermally-dissipating filler, a dispersing agent, a thickener, etc., are mixed together in a solvent is applied to a gas diffusing layer, for example, then dried in a dryer such that only the solvent evaporates first to form an intermediate layer precursor 11 on the surface of the gas diffusing layer, as shown in FIG. 3. In this state, the mixed components 12 such as the electron-conductive filler, the binder, the dispersing agent, etc., interconnect around the thermally-dissipating filler 13 to form a layer. By performing heat treatment on the gas diffusing layer with the intermediate layer precursor attached at a temperature at which the thermally-dissipating filler 13, and the dispersing agents, the thickeners, etc., are able to react or decompose, it is possible to form intermediate layers 5a and 5b easily that have satisfactory gas permeability. In this state, as shown in FIG. 4, the particles of the thermally-dissipating filler 13 that were disposed so as to contact each other dissipate to form macropores 10 (voids) that are continuous in a thickness direction of the intermediate layers 5a and 5b in a skeleton 14 that is constituted by the electron-conductive filler and binder. Here, it is preferable for the preliminary drying that evaporates the solvent to be between 40 degrees Celsius and 150 degrees Celsius, and it is desirable for the subsequent heat treatment temperature to be between 200 degrees Celsius and 450 degrees Celsius. It is undesirable for the heat treatment temperature to be higher than 450 degrees Celsius, because combustive or thermal decomposition may arise in the electron-conductive filler, binder, etc., constituting the skeleton 14.

### EXAMPLES

The present invention will now be explained further using examples.

### Example 1

(Preparation of Intermediate Layers Formed on Surfaces of Gas Diffusing Layers)

Carbon paper (TGP-H-090 manufactured by Toray Industries, Inc.) was immersed in a dilute solution of polytetrafluoroethylene (PTFE) aqueous dispersion (manufactured by Daikin Industries, Ltd.), dried, then heat-treated at 360 degrees Celsius to prepare a gas diffusing layer to which a water-repellent treatment had been applied. Acetylene black in which the mean particle diameter of primary particles was approximately 35 nm (Denka Black manufactured by Denki Kagaku Kogyo K.K.) functioning as an electron-conductive filler, a PTFE aqueous dispersion, a nonionic dispersing agent, 2% hydroxyethylcellulose (HEC) aqueous solution functioning as a thickener, and distilled water functioning as a solvent were mixed together and dispersed to form a paste, then polymethyl methacrylate (PMMA) spherical microparticles having a mean particle diameter of 8 μm (Techpolymer manufactured by Sekisui Plastics Co., Ltd.) functioning as a thermally-dissipating filler were added such that a solid content ratio (the volume fraction of PMMA particles in the paste) was 80 percent. This paste was applied to a surface of the gas diffusing layer constituted by the water-repellent treated carbon paper by screen printing, then the paste was dried by evaporating the solvent. A carbon paper with a porous intermediate layer attached was subsequently prepared by heat-treating this at 380 degrees Celsius to decompose the thermally-dissipating filler, the dispersing agent, and the thickener thermally. Here, the formed thickness of the intermediate layer was approximately 25 μm. Gas permeability of this carbon paper with the intermediate layer attached, measured using a gas permeability meter, was approximately 200 μm/(Pa·s). When a membrane constituted only by an intermediate layer was prepared and the void diameter distribution thereof was measured, the volume ratio occupied by voids having a void diameter that was greater than or equal to 1 μm and less than or equal to 30 μm was approximately 80 percent of the overall intermediate layer volume. The solid volume percentage was 10 percent.

(Formation of Catalyst Layers on Electrolyte Membranes)

Catalytic metals carried on carbon black (Vulcan XC-72R manufactured by Cabot) were used for the catalysts. Carbon black carrying 50 weight percent platinum was used for the cathode catalyst, and carbon black carrying 50 weight percent platinum-ruthenium-base metal was used for the anode catalyst.

Uniform pastes were obtained by adding perfluorosulfonic acid polyelectrolyte solution (Nafion (registered trademark) solution manufactured by DuPont) to each type of catalyst particle, and blending. Each of these catalyst pastes was screen-printed onto a polyethylene terephthalate (PET) film having a thickness of 50 μm, then drying was performed. Cathode and anode catalyst layers were formed on two surfaces of the polymer electrolyte membrane by sandwiching a polymer electrolyte film (Nafion (registered trademark) 112 membrane manufactured by DuPont) between the two films with the anode and cathode catalyst layers attached, hot-pressing at 130 degrees Celsius for two minutes, and removing the PET films. Each of the catalyst layers was formed so as to have a square shape having a length and breadth of 50 mm.

(Formation of Cell)

A polymer electrolyte fuel cell such as that shown in FIG. 1 was prepared by sandwiching a polymer electrolyte membrane with the catalyst layers attached described above between a pair of gas diffusing layers with the intermediate layers attached, and further sandwiching those between a pair of carbon plates in which gas channel grooves were disposed.

(Operation of Cell)

Hydrogen gas was supplied to an anode electrode side of this fuel cell, and air at normal pressure was supplied to a cathode electrode side. Flow rates were set such that the utilization factor of the hydrogen gas was 70 percent, and the oxygen utilization factor on the air side was 40 percent. The two gases were humidified using respective external humidifiers (not shown) before being supplied to the cell. Temperature was regulated such that the temperature of the cell was 80 degrees Celsius. Humidity of the supplied gases was regulated by the external humidifiers so as to maintain a dew point of 75 degrees Celsius on the anode side and a dew point of 70 degrees Celsius on the cathode side. The cell was operated at an electric current density of 300 mA/cm², and output voltage was measured at 24 hours and 1,000 hours after starting. Changes in cell voltage and cell resistance are shown in Table 1.

### Example 2

Preparation and operation of a cell were performed in a similar manner to that of Embodiment 1 except that PMMA microparticles having a mean particle diameter of 8 μm functioning as a thermally-dissipating filler were added such that the solid content ratio was 50 percent in the preparation of the intermediate layers. Here, the gas permeability of the carbon paper with the intermediate layer attached, measured using a gas permeability meter, was approximately 100 μm/(Pa·s). When a membrane constituted only by an intermediate layer was prepared and the void diameter distribution thereof was measured, the volume ratio occupied by voids having a void diameter that was greater than or equal to 1 μm and less than or equal to 30 μm was approximately 50 percent of the overall intermediate layer volume. The solid volume percentage was 30 percent. Changes in cell voltage and cell resistance are shown in Table 1.

### Example 3

Preparation and operation of a cell were performed in a similar manner to that of Embodiment 1 except that PMMA microparticles having a mean particle diameter of 8 μm functioning as a thermally-dissipating filler were added such that the solid content ratio was 87 percent in the preparation of the intermediate layers. Here, the gas permeability of the carbon paper with the intermediate layer attached, measured using a gas permeability meter, was approximately 230 μm/(Pa·s). When a membrane constituted only by an intermediate layer was prepared and the void diameter distribution thereof was measured, the volume ratio occupied by voids having a void diameter that was greater than or equal to 1 μm and less than or equal to 30 μm was approximately 87 percent of the overall intermediate layer volume. The solid volume percentage was 5 percent. Changes in cell voltage and cell resistance are shown in Table 1.

### Example 4

Preparation and operation of a cell were performed in a similar manner to that of Embodiment 1 except that PMMA microparticles having a mean particle diameter of 5 μm functioning as a thermally-dissipating filler were added such that the solid content ratio was 87 percent in the preparation of the intermediate layers. Here, the gas permeability of the carbon paper with the intermediate layer attached, measured using a gas permeability meter, was approximately 210 μm/(Pa·s). When a membrane constituted only by an intermediate layer was prepared and the void diameter distribution thereof was measured, the volume ratio occupied by voids having a void diameter that was greater than or equal to 1 μm and less than or equal to 30 μm was approximately 87 percent of the overall intermediate layer volume. The solid volume percentage was 5 percent. Changes in cell voltage and cell resistance are shown in Table 1.

### Example 5

Preparation and operation of a cell were performed in a similar manner to that of Embodiment 1 except that PMMA microparticles having a mean particle diameter of 12 μm functioning as a thermally-dissipating filler were added such that the solid content ratio was 87 percent in the preparation of the intermediate layers. Here, the gas permeability of the carbon paper with the intermediate layer attached, measured using a gas permeability meter, was approximately 220 μm/(Pa·s). When a membrane constituted only by an intermediate layer was prepared and the void diameter distribution thereof was measured, the volume ratio occupied by voids having a void diameter that was greater than or equal to 1 μm and less than or equal to 30 μm was approximately 87 percent of the overall intermediate layer volume. The solid volume percentage was 5 percent. Changes in cell voltage and cell resistance are shown in Table 1.

### Example 6

Preparation and operation of a cell were performed in a similar manner to that of Embodiment 1 except that PMMA microparticles having a mean particle diameter of 20 μm functioning as a thermally-dissipating filler were added such that the solid content ratio was 87 percent and the intermediate layers were formed to a thickness of 30 μm in the preparation of the intermediate layers. Here, the gas permeability of the carbon paper with the intermediate layer attached, measured using a gas permeability meter, was approximately 200 μm/(Pa·s). When a membrane constituted only by an intermediate layer was prepared and the void diameter distribution thereof was measured, the volume ratio occupied by voids having a void diameter that was greater than or equal to 1 μm and less than or equal to 30 μm was approximately 87 percent of the overall intermediate layer volume. The solid volume percentage was 5 percent. Changes in cell voltage and cell resistance are shown in Table 1.

### Example 7

Preparation and operation of a cell were performed in a similar manner to that of Embodiment 1 except that PMMA microparticles having a mean particle diameter of 30 μm functioning as a thermally-dissipating filler were added such that the solid content ratio was 87 percent and the intermediate layers were formed to a thickness of 40 μm in the preparation of the intermediate layers. Here, the gas permeability of the carbon paper with the intermediate layer attached, measured using a gas permeability meter, was approximately 240 μm/(Pa·s). When a membrane constituted only by an intermediate layer was prepared and the void diameter distribution thereof was measured, the volume ratio occupied by voids having a void diameter that was greater than or equal to 1 μm and less than or equal to 30 μm was approximately 87 percent of the overall intermediate layer volume. The solid volume percentage was 5 percent. Changes in cell voltage and cell resistance are shown in Table 1.

### Example 8

Preparation and operation of a cell were performed in a similar manner to that of Embodiment 1 except that PMMA microparticles having a mean particle diameter of 40 μm functioning as a thermally-dissipating filler were added such that the solid content ratio was 87 percent and the intermediate layers were formed to a thickness of 50 μm in the preparation of the intermediate layers. Here, the gas permeability of the carbon paper with the intermediate layer attached, measured using a gas permeability meter, was approximately 250 μm/(Pa·s). When a membrane constituted only by an intermediate layer was prepared and the void diameter distribution thereof was measured, the volume ratio occupied by voids having a void diameter that was greater than or equal to 1 μm and less than or equal to 30 μm was approximately 87 percent of the overall intermediate layer volume. The solid volume percentage was 5 percent. Changes in cell voltage and cell resistance are shown in Table 1.

### Example 9

Preparation and operation of a cell were performed in a similar manner to that of Embodiment 1 except that the intermediate layers were formed to a thickness of 110 μm in the preparation of the intermediate layers. Here, the gas permeability of the carbon paper with the intermediate layer attached, measured using a gas permeability meter, was approximately 95 μm/(Pa·s). When a membrane constituted only by an intermediate layer was prepared and the void diameter distribution thereof was measured, the volume ratio occupied by voids having a void diameter that was greater than or equal to 1 μm and less than or equal to 30 μm was approximately 80 percent of the overall intermediate layer volume. The solid volume percentage was 5 percent. Changes in cell voltage and cell resistance are shown in Table 1.

### Example 10

Preparation and operation of a cell were performed in a similar manner to that of Embodiment 1 except that PMMA microparticles having a mean particle diameter of 4 μm functioning as a thermally-dissipating filler were added such that the solid content ratio was 80 percent and the intermediate layers were formed to a thickness of 4 μm in the preparation of the intermediate layers. Here, the gas permeability of the carbon paper with the intermediate layer attached, measured using a gas permeability meter, was approximately 295 μm/(Pa·s). When a membrane constituted only by an intermediate layer was prepared and the void diameter distribution thereof was measured, the volume ratio occupied by voids having a void diameter that was greater than or equal to 1 μm and less than or equal to 30 μm was approximately 80 percent of the overall intermediate layer volume. The solid volume percentage was 7 percent. Changes in cell voltage and cell resistance are shown in Table 1.

### Example 11

Preparation and operation of a cell were performed in a similar manner to that of Embodiment 1 except that acetylene black, perfluorosulfonic acid polyelectrolyte solution, ethanol as a solvent, and distilled water were mixed together and dispersed to form a paste, then low-temperature thermally-dissipating spherical microparticles having a mean particle diameter of 8 μm (Techpolymer manufactured by Sekisui Plastics Co., Ltd.) functioning as a thermally-dissipating filler were added such that the solid content ratio (the volume fraction of thermally-dissipating microparticles in the paste) was 80 percent, then the paste was applied and the solvent dried, and a carbon paper with a porous intermediate layer attached was subsequently prepared by heat-treating at 250 degrees Celsius to decompose the thermally-dissipating filler thermally in the preparation of the intermediate layers. Here, the gas permeability of the carbon paper with the intermediate layer attached, measured using a gas permeability meter, was approximately 200 μm/(Pa·s). When a membrane constituted only by an intermediate layer was prepared and the void diameter distribution thereof was measured, the volume ratio occupied by voids having a void diameter that was greater than or equal to 1 μm and less than or equal to 30 μm was approximately 80 percent of the overall intermediate layer volume. The solid volume percentage was 10 percent. Changes in cell voltage and cell resistance are shown in Table 1.

### Comparative Example 1

Preparation and operation of a cell were performed in a similar manner to that of Embodiment 1 except that PMMA microparticles having a mean particle diameter of 8 μm functioning as a thermally-dissipating filler were added such that the solid content ratio was 30 percent in the preparation of the intermediate layers. Here, the gas permeability of the carbon paper with the intermediate layer attached, measured using a gas permeability meter, was approximately 60 μm/(Pa·s). When a membrane constituted only by an intermediate layer was prepared and the void diameter distribution thereof was measured, the volume ratio occupied by voids having a void diameter that was greater than or equal to 1 μm and less than or equal to 30 μm was approximately 30 percent of the overall intermediate layer volume. The solid volume percentage was 33 percent. Changes in cell voltage and cell resistance are shown in Table 1.

### Comparative Example 2

Preparation of a cell was performed in a similar manner to that of Embodiment 1 except that PMMA microparticles having a mean particle diameter of 8 μm functioning as a thermally-dissipating filler were added such that the solid content ratio was 95 percent in the preparation of the intermediate layers. However, it was impossible to form intermediate layers since the solid content was insufficient.

### Comparative Example 3

Preparation and operation of a cell were performed in a similar manner to that of Embodiment 1 except that no thermally-dissipating filler was added at all in the preparation of the intermediate layers. Here, the gas permeability of the carbon paper with the intermediate layer attached, measured using a gas permeability meter, was approximately 50 μm/(Pa·s). When a membrane constituted only by an intermediate layer was prepared and the void diameter distribution thereof was measured, the volume ratio occupied by voids having a void diameter that was greater than or equal to 1 μm and less than or equal to 30 μm was approximately 5 percent of the overall intermediate layer volume. The solid volume percentage was 35 percent. Changes in cell voltage and cell resistance are shown in Table 1.

### Comparative Example 4

Preparation and operation of a cell were performed in a similar manner to that of Embodiment 1 except that a polyvinylidene fluoride (PVDF) powder having a mean particle diameter of approximately 5 μm was used as a thermally-dissipating filler in the preparation of the intermediate layers. Here, the gas permeability of the carbon paper with the intermediate layer attached, measured using a gas permeability meter, was approximately 50 μm/(Pa·s). When a membrane constituted only by an intermediate layer was prepared and the void diameter distribution thereof was measured, the volume ratio occupied by voids having a void diameter that was greater than or equal to 1 μm and less than or equal to 30 μm was approximately 5 percent of the overall intermediate layer volume. The solid volume percentage was 35 percent. Changes in cell voltage and cell resistance are shown in Table 1.

Moreover, when a cross-sectional observation of the intermediate layers was performed after preparation of the intermediate layers, it was observed that the PVDF powder that was added as the polymer filler remained practically unchanged without dissipating.

TABLE 1

| | | Initial | Undervoltage |
|---|---|---|---|
| | Initial voltage | resistance | after 1,000 |
| | (mV) | (mΩ) | hours (mV) |
| Example 1 | 700 | 4.0 | 3 |
| Example 2 | 700 | 3.9 | 2 |
| Example 3 | 700 | 4.0 | 2 |
| Example 4 | 700 | 4.0 | 2 |
| Example 5 | 700 | 4.0 | 2 |
| Example 6 | 700 | 4.0 | 2 |
| Example 7 | 700 | 4.0 | 2 |
| Example 8 | 700 | 4.5 | 2 |
| Example 9 | 690 | 4.0 | 9 |
| Example 10 | 685 | 5.0 | 8 |
| Example 11 | 700 | 3.9 | 4 |
| Comparative | 690 | 3.8 | 15 |
| Example 1 | | | |
| Comparative | unmeasurable | unmeasurable | Unmeasurable |
| Example 2 | | | |
| Comparative | 670 | 3.8 | 20 |
| Example 3 | | | |
| Comparative | 670 | 4.5 | 20 |
| Example 4 | | | |

Each of the examples will now be investigated with reference to Table 1.

First, when Example 1 and Comparative Example 3 are compared, the volume ratio occupied by voids that have a void diameter that is greater than or equal to 1 μm and less than or equal to 30 μm was 5 percent in Comparative Example 3, whereas it was 80 percent in Example 1. The solid volume percentage was 5 percent in Comparative Example 3, whereas it was 10 percent in Example 1. From this, it can be seen that it is difficult to increase the volume ratio occupied by voids that have the above-mentioned void diameters and to reduce the solid volume percentage, but the volume ratio occupied by voids that have the above-mentioned void diameters can be increased and the solid volume percentage can be reduced by adding PMMA particles that constitute a thermally-dissipating filler. From Table 1, it can be seen that although initial resistance was slightly higher in Example 1 than in Comparative Example 3, initial voltage was high, and undervoltage after 1,000 hours was able to be reduced significantly. In other words, a fuel cell having extremely stable voltage characteristics compared to Comparative Example 3 was able to be produced in Example 1. This can be inferred to be due to gas permeability of the intermediate membranes being improved and accumulation of water in the intermediate layers being eliminated by making the added PMMA particles dissipate during the heat treatment, thereby improving gas circulation.

In Comparative Example 4, PVDF particles were used instead of PMMA particles. However, because the PVDF particles did not dissipate during the heat treatment, adding PVDF particles instead of PMMA particles did not lead to the volume ratio occupied by voids that have the previously-mentioned void diameters being increased or to the solid volume percentage being reduced. Thus, as can be seen from Table 1, Comparative Example 4 resulted in the initial resistance being high and the undervoltage after 1,000 hours also increasing significantly compared to Example 1. From the above, it can be seen that not all resin fillers can be used as the added filler, and it necessary to use a material that decomposes combustively (by oxidation reaction) or thermally at a predetermined temperature, in this case 380 degrees Celsius.

From Examples 1 through 3 and Comparative Examples 1 and 2, it can be seen that if the solid volume percentage is increased, the volume ratio occupied by voids that have the previously-mentioned void diameters is reduced. It can also be seen that if the solid volume percentage exceeds 30 percent, the volume ratio occupied by voids that have the previously-mentioned void diameters becomes less than 50 percent. It can also be seen that the intermediate layers are not formed if the solid volume percentage is reduced excessively. Thus, it is necessary to make the solid volume percentage greater than or equal to 3 percent in order to form the intermediate layers.

Although initial resistance was slightly lower in Comparative Example 1 than in Example 1, initial voltage was low, and undervoltage after 1,000 hours increased greatly. This can be inferred to be due to sufficient gas permeability not being achieved and to accumulation of water arising in the intermediate layers, thereby reducing gas circulation, since the volume ratio occupied by voids that have the previously-mentioned void diameters was low at 30 percent and the solid volume percentage was large at 33 percent. From Examples 1 through 3 and Comparative Example 1, it can be seen that the initial voltage can be increased and the undervoltage after 1,000 hours can be reduced significantly by making the volume ratio occupied by voids that have the previously-mentioned void diameters greater than or equal to 50 percent. From this, in order to maintain the initial electric cell characteristics for a long time, it is necessary to make the solid volume percentage less than or equal to 30 percent and make the volume ratio occupied by voids that have the previously-mentioned void diameters greater than or equal to 50 percent. Moreover, the upper limit of the volume ratio occupied by voids that have the previously-mentioned void diameters corresponds to when the solid volume percentage is set to 3 percent.

From Table 1, it can be seen that initial voltage can be increased and undervoltage after 1,000 hours can be significantly reduced if gas permeability is greater than or equal to 100 μm/(Pa·s). In other words, from the viewpoint of stabilization of voltage characteristics, it is preferable to make the gas permeability of the intermediate layers greater than or equal to 100 μm/(Pa·s).

In Example 9, the undervoltage after 1,000 hours in particular was increased compared to Example 1. This can be inferred to be due to accumulation of water in the intermediate layers occurring over a long period and reducing gas circulation since the gas permeability in Example 9 was slightly less at 95 μm/(Pa·s). In Example 9, the gas permeability was reduced greatly from 200 μm/(Pa·s) to 95 μm/(Pa·s) simply by changing the mean formed thickness of 25 μm in the intermediate layers according to Example 1 to 110 μm. Since the mean formed thickness of the intermediate layers affects gas permeability in this manner and gas flow resistance is increased when the mean formed thickness of the intermediate layers reaches 110 μm, it is preferable for the mean formed thickness to be set to less than or equal to 100 μm.

In Example 10, the initial voltage was reduced, the initial resistance was high, and the undervoltage after 1,000 hours was increased compared to Example 1. Since the mean formed thickness of the intermediate layers in Example 10 was thin at 4 μm, it can be inferred that the initial voltage was reduced and initial resistance was high because irregularities in the base material surface could no longer be absorbed, and power collection was only possible partially from the catalyst layers, giving rise to reaction concentration, and it can also be inferred that the undervoltage was increased because the portions where the reaction concentration arises deteriorate earlier with the passage of time. Consequently, since characteristics such as initial voltage, initial resistance, etc., deteriorate if the mean formed thickness of the intermediate layers is made too thin, it is preferable for the mean formed thickness of the intermediate layers to be made greater than or equal to 5 μm.

In Example 11, since characteristics that were generally similar to those of Example 1 were achieved, it can be seen that there is no problem even if a binder that exhibits comparatively hydrophilic characteristics is used.

Moreover, in the above explanation, intermediate layers are explained as being disposed between an anode catalyst layer and a gas diffusing layer and between a cathode catalyst layer and a gas diffusing layer, but it is only necessary for an intermediate layer to be disposed either between the anode catalyst layer and the gas diffusing layer or between the cathode catalyst layer and the gas diffusing layer.

As described above, because the solid volume percentage of the electron-conductive filler and the binder contained in the intermediate layers is greater than or equal to 3 percent and less than or equal to 30 percent, and voids that are distributed continuously in a thickness direction inside the intermediate layers are included, and the volume ratio occupied by voids that have a void diameter that is greater than or equal to 1 μm and less than or equal to 30 μm is greater than or equal to 50 percent of the overall intermediate layer volume, a polymer electrolyte fuel cell that has stable voltage characteristics can be achieved since it is possible to supply reactant gases from the gas diffusing layer to the catalyst layers efficiently and also possible to remove moisture that has been generated by the catalyst layers efficiently.

Because gas permeability (ISO standard) in the thickness direction of the intermediate layers has a value that is greater than or equal to 100 μm/(Pa·s), a polymer electrolyte fuel cell that has stable voltage characteristics can be achieved since it is possible to supply reactant gases from the gas diffusing layer to the catalyst layers efficiently and also possible to remove moisture that has been generated by the catalyst layers efficiently.

Because the electron-conductive filler is a carbon material, a polymer electrolyte fuel cell that has good voltage characteristics can be achieved since contact resistance between the catalyst layers and the gas diffusing layer is reduced and cell resistance is also reduced.

Because the binder is a fluorine resin material, it is possible to drain moisture that has been generated by the catalyst layers efficiently since intermediate layers that have high water repellency are achieved.

Because the mean formed thickness of the intermediate layers is greater than or equal to 5 μm and less than or equal to 100 μm, increases in gas permeation resistance and decreases in power collection efficacy in the intermediate layers can be suppressed. Thus, deterioration in the supply of reactant gases and drainage can be suppressed, and deterioration in voltage characteristics can also be suppressed.

Because a process in which a paste that contains an electron-conductive filler, a binder, a thermally-dissipating filler, additives, and a solvent is applied to a surface of a gas diffusing layer, a process in which the paste that has been applied to the gas diffusing layer is dried by evaporating the solvent, and a process in which an intermediate layer is formed integrally on the surface of the gas diffusing layer by heat-treating the gas diffusing layer to which the dried paste has been applied to a temperature that is greater than or equal to 200 degrees Celsius and less than or equal to 450 degrees Celsius are included, an intermediate layer having good gas permeability can be manufactured efficiently and easily.

Because the mean particle diameter of the thermally-dissipating filler is greater than or equal to 1 μm and less than or equal to 30 μm, voids that have a void diameter that is greater than or equal to 1 μm and less than or equal to 30 μm can be formed simply, enabling an intermediate layer having good gas permeability to be manufactured efficiently and easily.

Because the thermally-dissipating filler is a material of which greater than or equal to 90 percent decomposes combustively (by oxidation reaction) or thermally at a temperature that is greater than or equal to 200 degrees Celsius and less than or equal to 450 degrees Celsius, voids can be formed simply, enabling an intermediate layer having good gas permeability to be manufactured efficiently and easily.

Because the thermally-dissipating filler is a polymeric material, the thermally-dissipating filler is easily obtained and its decomposition products are also harmless, enabling intermediate membranes to be manufactured inexpensively without polluting the environment.

Because the polymeric material is a methacrylate ester polymer, a derivative of such polymers, or a mixture thereof, intermediate membranes that have superior environmental tolerance can be manufactured inexpensively.

Because the methacrylate ester polymer is polymethyl methacrylate or polybutyl methacrylate, intermediate membranes that have superior environmental tolerance can be manufactured inexpensively.

1. A polymer electrolyte fuel cell comprising:
a proton-conductive polymer electrolyte membrane;
anode and cathode catalyst layers that are disposed on opposite sides of said polymer electrolyte membrane;
gas diffusing layers that are disposed on opposite sides of said anode and cathode catalyst layers from said polymer electrolyte membrane and through which reactant gases diffuse to said anode and cathode catalyst layers; and
an intermediate layer that is disposed between at least one catalyst layer of said anode and cathode catalyst layers and at least one of said gas diffusing layers and that contains an electron-conductive filler and a binder, wherein
said intermediate layer has voids that are distributed continuously in a thickness directions,
said intermediate layer has a solid volume percentage that is at least 3 percent and no more than 30 percent, and
volume ratio occupied by voids that have a void diameter that is at least 1 μm and no larger than 30 μm is at least 50 percent of overall intermediate layer volume.

2. The polymer electrolyte fuel cell according to claim 1, wherein gas permeability (ISO standard) in a thickness direction of said intermediate layer is at least 100 μm/(Pa·s).

3. The polymer electrolyte fuel cell according to claim 1, wherein said electron-conductive filler is a carbon material.

4. The polymer electrolyte fuel cell according to claim 1, wherein said binder is a fluorine resin material.

5. The polymer electrolyte fuel cell according to claim 1, wherein said intermediate layer has a mean formed thickness that is at least 5 μm and no larger than 100 μm.

6. A method of manufacturing a polymer electrolyte fuel cell comprising a proton-conductive polymer electrolyte membranes anode and cathode catalyst layers that are disposed on opposite sides of the polymer electrolyte membranes gas diffusing layers that are disposed on opposite sides of the anode and cathode catalyst layers from the polymer electrolyte membrane and through which reactant gases diffuse to the anode and cathode catalyst layers, and an intermediate layer that is disposed between at least one catalyst layer of the anode and cathode catalyst layers and at least one of the gas diffusing layers and that contains an electron-conductive filler and a binder, said method comprising:
applying a paste that contains an electron-conductive filler, a binder, a thermally-dissipating filler, an additive, and a solvent to a surface of a gas diffusing layer;
drying said paste that has been applied to the gas diffusing layer by evaporating said solvent; and
forming an intermediate layer integrally on the surface of said gas difflusing layer by heat-treating said gas diffusing layer to which said paste has been applied at a temperature that is at least 200 degrees Celsius and no more than 450 degrees Celsius to dissipate said thermally-dissipating filler.

7. The method according to claim 6, wherein said thermally-dissipating filler has a mean particle diameter that is at least 1 μm and no larger than 30 μm.

8. The method according to claim 6, wherein at least 90 percent of said thermally dissipating filler decomposes combustively or thermally at a temperature that is at least 200 degrees Celsius and no higher than 450 degrees Celsius.

9. The method according to claim 8, wherein said thermally-dissipating filler is a polymeric material.

10. The method according to claim 9, wherein said thermally-dissipating filler is selected from the group

10. The method according to claim 9, wherein said thermally-dissipating filler is selected from the group consisting of a methacrylate ester polymer, a derivative of ethacrylate ester polymers, and mixtures thereof.

11. The method according to claim 10, wherein said methacrylate ester polymer is selected from the group consisting of polymethyl methacrylate and polybutyl methacrylate.
